(19) United States
(12) Patent Application Publication
(10) Pub. No.: US 2014/0255661 A1
(43) Pub. Date: Sep. 11, 2014

(54) PROCESS FOR PRODUCING PATTERNED COATINGS

(71) Applicants: Joseph Masrud, Cleveland Heights, OH (US); Lorenzo Mangolini, Riverside, CA (US); Eric L. Granstrom, Andover, MN (US); Arkady Garbar, Lakeville, MN (US); Dmitry Lekhtman, Afula (IL); Dov Zamir, Beerotaim (IL)

(72) Inventors: Joseph Masrud, Cleveland Heights, OH (US); Lorenzo Mangolini, Riverside, CA (US); Eric L. Granstrom, Andover, MN (US); Arkady Garbar, Lakeville, MN (US); Dmitry Lekhtman, Afula (IL); Dov Zamir, Beerotaim (IL)

(21) Appl. No.: 14/124,809

(22) PCT Filed: Jun. 7, 2012
(86) PCT No.: PCT/US2012/041348

§ 371 Date: Apr. 3, 2014

Related U.S. Application Data
(60) Provisional application No. 61/495,582, filed on Jun. 10, 2011.

(51) Int. Cl. B05D 1/28; B05D 3/12; B05D 1/32

(52) U.S. Cl. CPC B05D 1/28; B05D 1/322; B05D 3/12
USPC 428/195.1; 427/271; 427/278; 427/272; 427/108; 427/299

(57) ABSTRACT

Methods of producing patterned articles using a composition that includes a non-volatile component in a volatile liquid carrier, where the liquid carrier is in the form of an emulsion comprising a continuous phase and a second phase in the form of domains dispersed in the continuous phase.

### CROSS-REFERENCE TO RELATED APPLICATIONS

This application claims priority to U.S. Provisional Application Ser. No. 61/495,582, filed on Jun. 10, 2011, the content of which is incorporated herein by reference in its entirety.

### TECHNICAL FIELD

This invention relates to forming patterned coatings on substrates.

### BACKGROUND

Transparent, conductive coatings are useful in a variety of electronic devices. For example, these coatings are useful in applications that require electrostatic dissipation, electromagnetic interference (EMI) shielding, transparent conductive layers, and the like.

Specific examples of applications include optical displays, touch screen displays, wireless electronic boards, photovoltaic devices, conductive textiles and fibers, heaters, organic light emitting diodes (OLEDS), electroluminescent displays, and electrophoretic displays (e.g., e-paper).

U.S. Pat. Nos. 7,601,406; 7,566,360; and 7,736,693, which are assigned to the same assignee as the present application and incorporated by reference in their entirety, describe transparent, conductive coatings formed from the self-assembly of electrically conductive nanoparticles that are coated from an emulsion onto a substrate, followed by drying to remove the liquid carrier. Removal of the liquid carrier causes the nano-particles to self-assemble and form a series of interconnected traces defining a network of randomly shaped cells. The network is visible under an optical microscope. The resulting coating is both transparent to visible light (400-800 nm) and electrically conductive. While this coating has many advantages over previous transparent conductive coatings, especially in ease of manufacture and cost, the randomness of the cell shape and the inability to fine tune cell size and shape results in less than optimum performance in some product applications.

### SUMMARY

The present invention utilizes the many advantages of the emulsion-based, self-assembled nanoparticle coatings of the prior art, but also provides the additional advantages of directing the nanoparticle assembly to coatings with controlled cell size and shape.

In one aspect, there is described a method of producing an article that includes: (a) providing a composition that includes a non-volatile component in a volatile liquid carrier, where the liquid carrier is in the form of an emulsion comprising a continuous phase and a second phase in the form of domains dispersed in the continuous phase; (b) coating the composition on a surface of an unpatterned substrate and drying the composition to remove the liquid carrier while applying an outside force during the coating and/or drying to cause selective growth of the dispersed domains, relative to the continuous phase, in selected regions of the substrate. Application of the outside force causes the non-volatile component to self-assemble and form a coating in the form of a pattern that includes traces defining cells having a regular spacing, determined by the configuration of the outside force, on the surface of the substrate.

A “non-volatile component” is a component that remains on the surface of the substrate under conditions (temperature, pressure, relative humidity) used to coat and dry the composition. Conversely, a “volatile component” is a component that evaporates under these conditions.

Examples of suitable non-volatile components include nanoparticles, e.g., metal nanoparticles. In some implementations, the dispersed domains of the emulsion are aqueous domains, while the continuous phase includes an organic solvent that evaporates more quickly than the aqueous domains. In other implementations, the dispersed domains are organic solvents and the continuous phase includes an aqueous liquid that evaporates more quickly than the organic domains.

The spacing of cells, as noted above, is determined by the configuration of the outside force. The spacing between individual features of the outside force may influence the extent to which the cell spacing replicates the configuration of the outside force. In some implementations, the outside force is configured to include a plurality of features characterized by a center-to-center spacing between features ranging from 10 μm to 10 mm, 30 μm to 3 mm, or 50 μm to 2 mm.

In some implementations, applying the outside force includes coating the composition on the surface of the substrate using a Mayer rod. In other implementations, applying the outside force includes coating the composition on the surface of the substrate using a gravure cylinder. In some implementations, applying the outside force included covering the coated emulsion with a mask during drying of the emulsion.

In some implementations the traces are solid traces and the cells are in the form of voids. In other implementations, the traces are in the form of voids and the cells are filled.

In some implementations, the substrate, prior to coating, is transparent to visible light (i.e. has a transmission of at least 60% to light having wavelengths in the range of 400-800 nm). The coating process yields an article that is both transparent to visible light and electrically conductive, such as having a sheet resistance of 500 Ohms/square or less, or preferably 50 Ohm/sq or less.

In a second aspect, there is described a method of producing an article that includes: (a) providing a substrate comprising a primer layer on a surface of the substrate; (b) treating the primer layer to form a patterned primer layer; (c) coating the patterned primer layer with a composition comprising a non-volatile component in a volatile liquid carrier, the liquid carrier being in the form of an emulsion comprising a continuous phase and a second phase in the form of domains dispersed in the continuous phase; and (d) drying the composition to remove the liquid carrier. Upon drying, the non-volatile component self-assembles to form a coating in the form of a pattern that includes traces defining cells having a regular spacing, determined by the patterned primer layer, on the surface of the substrate.

The process may be used to produce patterned coatings having a variety of properties and structures. For example, it may be used to produce patterned coatings that are transparent and electrically conductive. These coatings find use in applications such as solar cells, flat panel displays for televisions and computers, touch screens, electromagnetic interference filters, and the like. Because the size and shape of the openings in the spaces in the pattern are controlled by the configuration of the applied force, it is possible to prepare patterns tailored to the end use application of the coating.

The widths of the traces defining the spaces in the pattern are determined primarily by the composition and drying properties of the emulsion. It is thus possible to form finer traces than are possible with conventional printing techniques. For example, while conventional printing techniques such as ink jet printing can achieve printed lines having a width of 50 microns, the process of the present invention could produce traces as low as 10 microns in width. Thinner traces can improve the transparency of the coating.

In addition to advantages over conventional printing techniques, the process also may offer advantages over self-assembled processes that yield randomly shaped cells. For example, in electromagnetic transmission applications, controlling the geometry of the coating may be important for selectivity in transmission/reflection of radiation. Specific geometries may be chosen that may allow narrow frequency bands of radiation to be treated very differently (transmitted, reflected, or diffracted), thereby allowing fabrication of a narrow pass or narrow blocking band filter.

The present invention may also offer advantages in preparing active electrodes for technologies such as projected capacitive touchscreens. For projected capacitive touchscreens, many manufacturers conventionally use transparent conductive coatings as electrodes, and are required to pattern very narrow lines of such materials. The present invention may allow formation of a narrow pattern while maintaining tight control of the distribution of resistances of the pattern.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1(a) is an optical micrograph of a patterned coating prepared using a nanoparticle-containing emulsion and a gravure cylinder.

FIG. 1(b) is an optical micrograph of the gravure cylinder used to prepare the coating shown in FIG. 1(a).

FIG. 2(a) is an optical micrograph of a patterned coating prepared using a nanoparticle-containing emulsion and a second gravure cylinder.

FIG. 2(b) is a drawing of the patterning of the gravure cylinder used to prepare the coating shown in FIG. 2(a).

FIGS. 3 and 4 are optical micrographs of a patterned coating prepared using a nanoparticle-containing emulsion and a Mayer rod (2 passes).

FIG. 5 is an optical micrograph of a comparative coating prepared using a nanoparticle-containing emulsion and a Mayer rod (1 pass).

FIGS. 6(a)-(i) are schematic drawings of various masks used to prepare patterned coatings. The designation “19.05” refers to the dimensions of the mask in millimeters.

FIGS. 7(a)-(i) are schematic drawings showing the dimensions (hole diameter or line width, and spacing) of the masks depicted in FIGS. 6(a)-(i).

FIGS. 8(a)-(i) are optical micrographs of patterned coatings prepared using a nanoparticle-containing emulsion and the masks depicted in FIGS. 6(a)-(i).

Like reference symbols in the various drawings indicate like elements.

### DETAILED DESCRIPTION

A method of forming a patterned coating on the surface of an unpatterned substrate includes applying a coating composition to the surface of the substrate. The coating composition includes a non-volatile component (as defined in the Summary) and a liquid carrier. The liquid carrier is in the form of an emulsion having a continuous phase and domains dispersed in the continuous phase.

Examples of suitable non-volatile components include metal and ceramic nanoparticles. The nanoparticles preferably have a D₉₀ value less than about 100 nanometers. Specific examples include metal nanoparticles prepared according to the process described in U.S. Pat. No. 5,476,535 and U.S. Pat. No. 7,544,229, both of which are incorporated by reference in their entirety. As described in these two patents, the nanoparticles are generally prepared by forming an alloy between two metals; such as an alloy between silver and aluminum, leaching one of the metals, such as the aluminum, using a basic or acidic leaching agent to form a porous metal agglomerate; and then disintegrating the agglomerate (e.g., using a mechanical disperser, a mechanical homogenizer, an ultrasonic homogenizer, or a milling device) to form nanoparticles. The nanoparticles may be coated prior to disintegration to inhibit agglomeration.

Examples of useful metals for making the nanoparticles include silver, gold, platinum, palladium, nickel, cobalt, copper, titanium, iridium, aluminum, zinc, magnesium, tin, and combinations thereof. Examples of useful materials for coating the nanoparticles to inhibit agglomeration include sorbitan esters, polyoxyethylene esters, alcohols, glycerin, polyglycols, organic acid, organic acid salts, organic acid esters, thiols, phosphines, low molecular weight polymers, and combinations thereof.

The concentration of the non-volatile component (e.g., nanoparticles) in the liquid carrier generally ranges from about 1-50 wt. %, preferably 1-10 wt. %. The specific amount is selected to yield a composition that may be coated on the substrate surface. When an electrically conductive coating is desired, the amount is selected to yield an appropriate level of conductivity in the dried coating.

The liquid carrier is in the form of an emulsion featuring a continuous phase and domains dispersed in the continuous phase. In some implementations, the emulsion is a water-in-oil (W/O) emulsion in which one or more organic liquids form the continuous phase and one or more aqueous liquids form the dispersed domains. In other implementations, the emulsion is an oil-in-water (O/W) emulsion in which one or more aqueous liquids form the continuous phase and one or more organic liquids form the dispersed domains. In both cases, the aqueous and organic liquids are substantially immiscible in each other such that two distinct phases are formed.

Examples of suitable aqueous liquids for either a W/O or O/W emulsion include water, methanol, ethanol, ethylene glycol, glycerol, dimethyformamide, dimethylacetamide, acetonitrile, dimethylsulfoxide, N-methylpyrrolidone, and combinations thereof. Examples of suitable organic liquids for either a W/O or O/W emulsion include petroleum ether, hexanes, heptanes, toluene, benzene, dichloroethane, trichloroethylene, chloroform, dichloromethane, nitromethane, dibromomethane, cyclopentanone, cyclohexanone, and combinations thereof. Solvents should be selected so that the solvent of the continuous phase of the emulsion evaporates faster than the solvent of the dispersed domains. For example, in some implementations, the emulsion is a W/O emulsion where the organic liquid evaporates more quickly than the aqueous liquid.

The liquid carrier may also contain other additives. Specific examples include reactive or non-reactive diluents, oxygen scavengers, hard coat components, inhibitors, stabilizers, colorants, pigments, IR absorbers, surfactants, wetting agents, leveling agents, flow control agents, rheology modifiers, slip agents, dispersion aids, defoamers, binders, adhesion promoters, corrosion inhibitors, and combinations thereof.

A variety of unpatterned substrates can be used. If the objective is to prepare an article having a transparent, conductive coating, the substrate preferably is substantially transparent to light in the visible region (400-800 nm). Examples of suitable substrates include glass, polymeric materials (e.g., polymethylmethacrylate, polyethylene, polyethylene terephthalate, polypropylene, or polycarbonate), ceramics (e.g., transparent metal oxides), and semiconductive materials (e.g., silicon or germanium). The substrate may be used as is or pre-treated to alter its surface properties. For example, the substrate may be pre-treated to improve adhesion between the coating and the substrate surface, or to increase or control the surface energy of the substrate. Both physical and chemical pre-treatments can be used. Examples of physical pre-treatments include corona, plasma, ultraviolet, thermal, or flame treatment. Examples of chemical pre-treatments include etchants (e.g., acid etchants), primers, anti-reflection coatings, or hard-coat layers (e.g., to provide scratch-resistance).

The composition is coated on a surface of the substrate and dried to remove the liquid carrier while applying an outside force during the coating and/or drying to cause selective growth of the dispersed domains, relative to the continuous phase, in selected regions of the substrate. The outside force may be applied in a continuous fashion, such as in a roll-to-roll process, it may be applied in discontinuous fashion, such as in a step-and-repeat or batch process. Furthermore, the force may be applied by contact or non-contact means. Application of the outside force causes the non-volatile component to self-assemble and form a coating in the form of a pattern that includes traces defining cells having a regular spacing (for instance, a regular center-to-center spacing), determined by the configuration of the outside force.

Application of the outside force may be accomplished, for example, by depositing the composition on the substrate surface and then passing a Mayer rod over the composition. Alternatively, the composition can be applied using a gravure cylinder. Typically, both the Mayer rod and the gravure cylinder contact the composition. In another implementation, the composition may be deposited on the substrate surface, after which a lithographic mask is placed over the composition, but typically not in contact with the composition. In the case of the mask, as the composition dries, the mask forces the composition to adopt a pattern corresponding to the pattern of the mask.

In each case, it is the outside force that governs the pattern (specifically, the center-to-center spacing between cells in the dried coating). However, the width of the traces defining the cells is not directly controlled by the outside force. Rather, the properties of the emulsion and drying conditions are the primary determinant of the trace width. In this fashion, lines substantially narrower than the outside force can be readily manufactured, without requiring the difficulty and expense of developing processes, masters, and materials having very fine linewidth. Fine linewidth can be generated with the emulsion and drying process. However, the outside force can be used (easily and inexpensively) to control the size, spacing, and orientation of the cells of the network.

The spacing between individual features of the outside force may influence the extent to which the cell spacing replicates the configuration of the outside force. In some implementations, the outside force is configured to include a plurality of features characterized by a center-to-center spacing between features ranging from 10 μm to 10 mm, 30 μm to 3 mm, or 50 μm to 2 mm. In the case of a Mayer rod, the individual features are the coiled wires of the rod, and the center-to-center spacing between features refers to the distance between a pair of coils. In the case of a gravure cylinder, the features are the individual wells that make up the cylinder, and the center-to-center spacing between features refers to the distance between a pair of wells. In the case of a lithographic mask, the features are the openings of the mask, and the center-to-center spacing between features refers to the distance between a pair of openings.

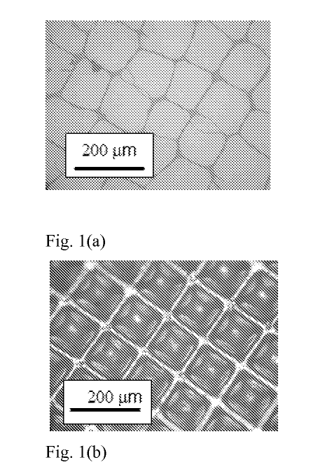

The process will now be illustrated with reference to a metal nanoparticle-containing W/O emulsion coating composition and a gravure cylinder as the means for applying the outside force. A microphotograph of the surface of a gravure cylinder is shown in FIG. 1(b). The gravure cylinder includes a plurality of cavities. Each of the cavities is separated by a fixed center-to-center distance. During coating onto the substrate surface, the coating composition fills the cavities of the gravure cylinder and is deposited on the substrate surface. The water and organic solvents evaporate as the coating dries, causing the metal nanoparticles (i.e. the non-volatile component) to self-assemble and form traces defining cells on the surface of the substrate.

The final, dried, patterned coating is shown in FIG. 1(a). It features metal traces defining a plurality of cells. In this particular implementation, the cells are voids while the traces are electrically conductive, resulting in a transparent, conductive coating. The center-to-center spacing of the cells is substantially the same as the center-to-center distance between the cavities of the gravure cylinder.

A method is also described in which a primer layer is applied to a substrate surface and then patterned, e.g., using a gravure roller. The above-described emulsion is then applied to the patterned primer layer. After drying, a pattern forms that substantially replicates the pattern formed in the primer layer.

The invention will now be described further by way of the following examples.

### EXAMPLES

### Glossary

| Component | Function | Chemical description | Source |
|---|---|---|---|
| BYK-410 | Liquid rheology | Solution of a modified urea | BYK USA, |
| | additive | | Wallingford, CT |
| Byk-106 | Wetting and | Salt of a polymer with acidic | BYK USA |
| (Disperbyk-106) | dispersing | groups | |
| | additive | | |
| Cymel 1168 | Cross-linking | Methylated, isobutylated | Cytec Industries, |
| | agent | melamine-formaldehyde | Woodland park, |
| | | | NJ |
| K-Flex A307 | Flexibility | Linear, saturated, aliphatic | King Industries, |
| | modifier | polyester diol with primary | Norwalk, CT |
| | | hydroxyl groups | |
| Span 60 | | Sorbitan monostearate | Sigma-Aldrich, |
| | | | St. Louis, MO |
| Nacure 2501 | Blocked acid | Amine blocked | King Industries |
| | catalyst | toluenesulfonic acid | |
| BYK-348 | Silicone | | BYK USA |
| | surfactant | | |
| Silver nanopowder | | Silver nanoparticles | Cima Nanotech, |
| (silver nanoparticle | | | Inc., Israel |
| powder P204) | | | |
| Ethyl cellulose | | | Sigma-Aldrich |
| Cymel LF 303 | Cross-linking | Hexamethoxymethyl | Cytec Industries |
| | agent | melamine | |
| | Emulsifier | Poly[dimethylsiloxane-co-[3- | Sigma-Aldrich |
| | | (2-(2- | |
| | | hydroxyethoxy)ethoxy)- | |
| | | propyl]methylsiloxane], | |
| | | viscosity | |
| | | 75 cSt | |
| Sodium dodecyl | Surfactant | | Sigma-Aldrich |
| sulfate | | | |
| Synperonic NP | Surfactant | | Sigma-Aldrich |

### Example 1

A water-in-oil emulsion with metal nanoparticles was prepared by mixing the following according to methods described in U.S. Pat. No. 7,601,406. All components except the sodium dodecyl sulfate in water were premixed using sonication, then the sodium dodecyl sulfate in water was added and again sonicated:

| Component | wt % | Supplier |
|---|---|---|
| Byk 410 | 0.17 | Byk-Chemie GmbH |
| Aniline | 0.16 | Sigma Aldrich Co. |
| Byk 106 | 0.15 | Byk-Chemie GmbH |
| Cyclohexanone | 3.89 | Gadot Biochemical Industries Ltd. |
| Toluene | 56.36 | Gadot Biochemical Industries Ltd. |
| Silver nanopowder | 1.08 | Cima Nanotech, Inc. |
| Cymel 1168 | 0.14 | Cytec Industries Inc. |
| K-Flex A307 | 0.06 | King Industries Inc. |
| Span 60 | 0.16 | Sigma Aldrich Co. |
| Nacure 2501 | 0.14 | King Industries Inc. |
| Cyclohexane | 4.12 | Gadot Biochemical Industries Ltd. |
| 0.04 wt % sodium dodecyl | 33.41 | Sigma Aldrich Co. |
| sulfate in water | | |
| 2-amino-1-butanol | 0.16 | Sigma Aldrich Co. |

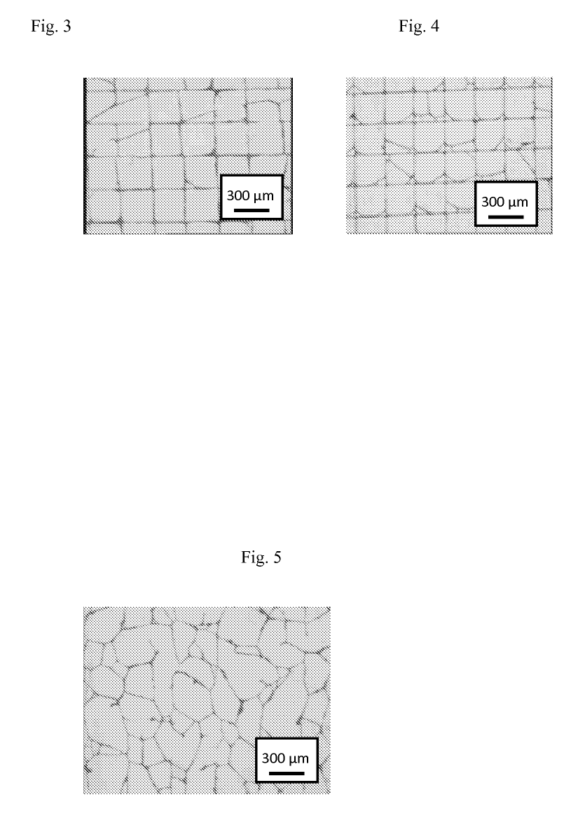

The emulsion was deposited on an A4-sized optical grade polyethylene terephthalate (PET) film substrate (CH285, NanYa Plastics, Taiwan). The film substrate was previously treated with corona to increase the surface energy of the film in a uniform manner over the entire surface. A wire wound Mayer rod having a pitch of 375 microns was passed over the surface of the film in one direction. The same emulsion (i.e. not a new aliquot) was then applied to the surface with same Mayer rod in a cross-wise direction at a 90° angle relative to the first pass of the Mayer rod to provide a wet coating with a thickness of 28 microns. The aqueous and organic liquids in the coating were then allowed to evaporate fully at ambient temperature. The resulting self-assembled pattern of metal nanoparticles exhibited non-random square-shaped cells with cell length and width of approximately 350 microns, as depicted in FIGS. 3 and 4. The resulting film was then heat treated at 150 deg. C for 2 min. in a universal hot air oven to sinter the metal nanoparticles. The sample gave a sheet resistance of 68 ohm/sq (sheet resistance was measured using a Loresta-GP MCP T610 4 point probe, Mitsubishi Chemical, Chesapeake, Va.), light transmittance in the visible range of 85.2%, and haze of 3.8% (light transmittance was measured by taking the ratio of measured light incident on a Greenlee Digital Light Meter 93 172, (Greenlee, Southhaven, Miss.), when placed underneath the film to the light incident on the same meter in the absence of such a film in conventional fluorescent bulb lab lighting benchtop conditions).

By comparison, the pattern resulting from this type of emulsion deposited with a single pass of the Mayer rod, exhibited randomly shaped cells, as depicted in FIG. 5.

### Example 2

A 4 mil thick PET film substrate (Lumirror U46, Toray Industries, Japan) was coated with primer composed of 0.28 wt % Poly[dimethylsiloxane-co43-(2-(2-hydroxyethoxy)ethoxy)propyl]methylsiloxane] (Aldrich Cat. No. 480320) and 0.6 wt % Synperonic NP (Fluka Cat. No 86209) in acetone solution. The primer was coated via Mayer rod to have a wet thickness of approximately 13 microns, prior to drying in air. The primer coated film was then coated with a water-in-oil emulsion having the following formula:

| Component | Wt (g) (wt %) | | Supplier |
|---|---|---|---|
| Cymel LF 303 | 0.025 | (0.08) | Cytec Industries Inc. |
| K-Flex A307 | 0.078 | (0.24) | King Industries Inc. |
| Nacure 2501 | 0.093 | (0.29) | King Industries Inc. |
| Span 60 | .052 | (0.16) | Sigma Aldrich Co. |
| Byk 410 | .092 | (0.28) | Byk-Chemie GmbH |
| Cyclohexanone | 1.638 | (5.04) | Gadot Biochemical |
| | | | Industries Ltd. |
| Aniline | .03 | (0.09) | Sigma Aldrich Co. |
| Toluene | 18.459 | (56.84) | Gadot Biochemical |
| | | | Industries Ltd. |
| Silver Nanopowder | 1.3 | (4.0) | Cima Nanotech, Inc. |
| 0.02 wt % Byk 348 | 10.71 | (32.98) | Byk-Chemie GmbH |
| in water | | | |

The emulsion was prepared by mixing the ingredients according to methods described in U.S. Pat. No. 7,601,604. The emulsion was coated at a wet thickness of approximately 30 microns via a single pass of a Mayer rod.

Immediately after draw-down, a mask was placed over the emulsion as it was drying. Spacers (2 layers of transparent adhesive tape with total thickness of about 100 microns) placed on the mask were used to ensure that the mask did not make direct physical contact with the wet coating. The mask was then removed approximately 5 minutes after draw-down, at which point the coating was substantially dry.

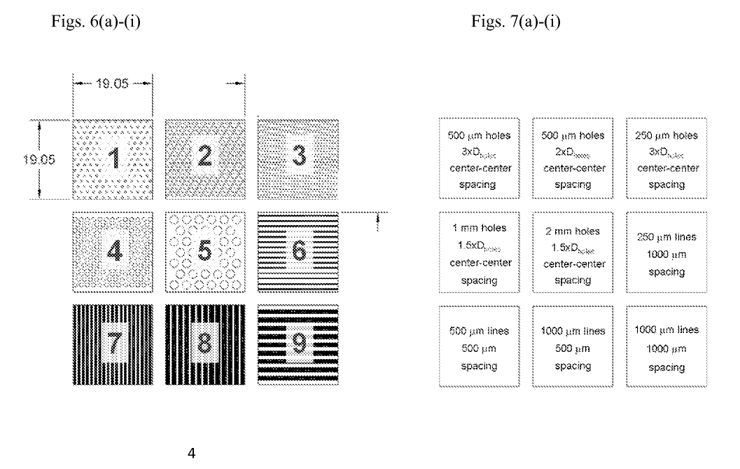

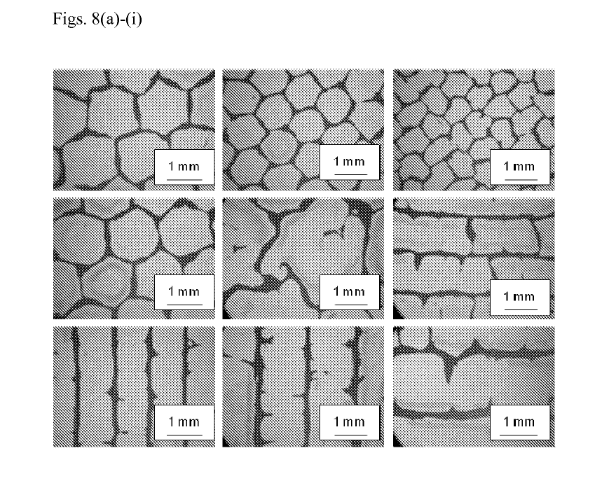

The mask spatially modulated the emulsion drying such that the resulting pattern of self-assembled nanoparticles reproduced the symmetry of the selected mask. The nine masks illustrated in FIGS. 6(a)-(i), for which the geometries are depicted in FIGS. 7(a)-(i), were used to produce the hexagonal and linear patterns in FIGS. 8(a)-(i), respectively.

The center-to-center spacing of the holes in FIGS. 7(a)-(e) were as follows:

FIG. 7(a): 1.5 mm

FIG. 7(b): 1.0 mm

FIG. 7(c): 0.75 mm

FIG. 7(d): 1.5 mm

FIG. 7(e): 3.0 mm

In the case of FIGS. 7(f)-i), line widths, spacing between lines, and center-to-center spacing were as follows:

FIG. 7(f): line width=250 μm
spacing between lines=1000 μm
center-to-center spacing=1250 μm

FIG. 7(g): line width=500 μm
spacing between lines=500 μm
center-to-center spacing=100 μm

FIG. 7(h): line width=1000 μm
spacing between lines=500 μm
center-to-center spacing=1500 μm

FIG. 7(i): line width=1000 μm
spacing between lines=1000 μm
center-to-center spacing=2000 μm

The “lines” are the openings in the mask and the “spacing between lines” refers to the solid area between the lines.

Note that the masks shown in in FIGS. 6(a)/7(a) and 6(d)/7(d) have the same center-to-center distance between the holes (1.5 mm), but different hole sizes (0.5 mm v. 1.0 mm). Nevertheless, the resulting micrographs of the respective patterns in FIGS. 8(a) and (d) show nearly identical trace patterns. In both cases, the resulting cell line width is about 100-200 microns, which is less than the shadowed distance between adjacent holes in the masks. This illustrates the fact that the width of the traces is a function of the properties of the emulsion, rather than being strictly defined by the finest dimensions of the mask, again demonstrating a pattern generation technique that can consistently make fine resolution feature owing to an emulsion without requiring expensive/difficult fine resolution mastering equipment.

### Example 3

A 4 mil thick PET film substrate (Lumirror U46, Toray Industries, Japan) was coated with primer composed of 0.28 wt % Poly[dimethylsiloxane-co43-(2-(2-hydroxyethoxy)ethoxy)propyl]metholsiloxane] (Aldrich Cat. No. 480320) and 0.6 wt % Synperonic NP (Fluka Cat. No 86209) in acetone solution. The primer was coated 13 microns via Mayer rod to have a wet thickness of approximately 13 microns, prior to drying in air. The primer coated film was then coated with a water-in-oil emulsion. The emulsion had the following formula:

| Component | Wt (g) (wt %) | | Supplier |
|---|---|---|---|
| Cymel LF 303 | 0.025 | (0.08) | Cytec Industries Inc. |
| K-Flex A307 | 0.078 | (0.24) | King Industries Inc. |
| Nacure 2501 | 0.093 | (0.29) | King Industries Inc. |
| Ethyl Cellulose | 0.005 | (0.02) | Sigma Aldrich Co. |
| 2-Amino-1-Butanol | 0.05 | (0.15) | Sigma Aldrich Co. |
| Byk 410 | .091 | (0.28) | Byk-Chemie GmbH |
| Span 60 | .052 | (0.16) | Sigma Aldrich Co. |
| Cyclohexanone | 1.638 | (5.04) | Gadot Biochemical |
| | | | Industries Ltd. |
| Aniline | .03 | (0.09) | Sigma Aldrich Co. |
| Toluene | 18.459 | (56.74) | Gadot Biochemical |
| | | | Industries Ltd. |
| Silver Nanopowder | 1.3 | (4.00) | Cima Nanotech, Inc. |
| 0.02 wt % Byk 348 | 10.71 | (32.92) | Byk-Chemie GmbH |
| in water | | | |

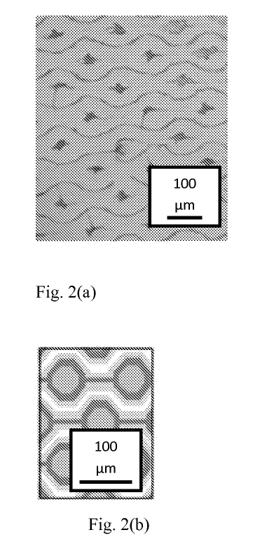

Approximately 2 mL of emulsion was placed between the doctor blade and annilox roller (150 LPI tool ref 71) of a Pamarco roto-proofer (Global Graphics, Roselle, N.J.). The emulsion was deposited on the primer coated film by rolling the roto-proofer across the surface of the film. Upon drying in air a reasonably regular square array was formed, with most of the line widths narrower than the line widths between the annilox roller cells. The pattern and cylinder are shown in FIGS. 1(a) and 1(b), respectively. The results illustrate that the width of the traces is a function of the properties of the emulsion, rather than being strictly defined by the finest dimensions of the annilox roller, again demonstrating a pattern generation technique that can consistently make fine resolution features without requiring expensive/difficult fine resolution mastering equipment. The pattern prepared using a different cylinder, shown in FIG. 2(b), is shown in FIG. 2(a).

### Example 4

A regular square array, similar to the array formed in Example 3, was prepared as follows.

The primer-coated PET substrate described in Example 3 was prepared and the roto-proofer, with no coating solution, was rolled across the surface of the primer film. Immediately thereafter, approximately 3 mL of the emulsion described in Example 3 was deposited in the form of a bead across one end of the film. Using a Mayer rod, the emulsion was drawn down across the film at a wet thickness of approximately 30 microns. After drying, the self-assembled pattern resembled in shape and size the pattern of the annilox roller cells of the roto-proofer.

A number of embodiments of the invention have been described. Nevertheless, it will be understood that various modifications may be made without departing from the spirit and scope of the invention. Accordingly, other embodiments are within the scope of the following claims. For example, the non-volatile component (e.g., metal nanoparticles) can form the cells, and the traces defining and separating the cells can be in the form of voids.

What is claimed is:

1. A method of producing an article comprising:
(a) providing a composition comprising a non-volatile component in a volatile liquid carrier,
wherein the liquid carrier is in the form of an emulsion comprising a continuous phase and a second phase in the form of domains dispersed in the continuous phase,
(b) coating the composition on a surface of an unpatterned substrate and drying the composition to remove the liquid carrier while applying an outside force during the coating and/or drying to cause selective growth of the dispersed domains, relative to the continuous phase, in selected regions of the substrate,
whereupon the non-volatile component self-assembles to form a coating in the form of a pattern that includes traces defining cells having a regular spacing, determined by the configuration of the outside force, on the surface of the substrate.

2. The method of claim 1 wherein the non-volatile component comprises nanoparticles.

3. The method of claim 2 wherein the nanoparticles comprises metal nanoparticles.

4. The method of claim 1 wherein the configuration of the outside force comprises a plurality of features characterized by a center-to-center spacing between individual features ranging from 10 μm to 10 mm.

5. The method of claim 4 wherein the center-to-center spacing between individual features ranges from 30 μm to 3 mm.

6. The method of claim 4 wherein the center-to-center spacing between individual features ranges from 50 μm to 3 mm.

7. The method of claim 1 wherein applying the outside force comprises coating the composition on the surface of the substrate using a Mayer rod.

8. The method of claim 1 wherein applying the outside force comprises coating the composition on the surface of the substrate using a gravure cylinder.

9. The method of claim 1 wherein applying the outside force comprises placing a lithographic mask over the composition on the surface of the substrate during drying.

10. The method of claim 1 wherein the traces are solid traces and the cells are in the form of voids.

11. The method of claim 1 wherein the traces are in the form of voids and the cells are filled.

12. The method of claim 1 wherein the domains dispersed in the continuous phase comprise aqueous domains, and the continuous phase comprises an organic solvent that evaporates more quickly than the aqueous domains.

13. The method of claim 1 wherein the substrate, prior to coating, is transparent to visible light, and the article formed after coating is transparent to visible light and electrically conductive.

14. An article prepared according to the method of claim 1.

15. A method of producing an article comprising:
(a) providing a substrate comprising a primer layer on a surface of the substrate;
(b) treating the primer layer to form a patterned primer layer;
(c) coating the patterned primer layer with a composition comprising a non-volatile component in a volatile liquid carrier, wherein the liquid carrier is in the form of an emulsion comprising a continuous phase and a second phase in the form of domains dispersed in the continuous phase; and
(d) drying the composition to remove the liquid carrier, whereupon the non-volatile component self-assembles to form a coating in the form of a pattern that includes traces defining cells having a regular spacing, determined by the patterned primer layer, on the surface of the substrate.

16. An article prepared according to the method of claim 15.
